(19) United States
(12) Patent Application Publication
(10) Pub. No.: US 2024/0198473 A1
(43) Pub. Date: Jun. 20, 2024

(54) VIBRATION DETECTION DEVICE

(71) Applicant: FANUC CORPORATION, Minamitsuru-gun, Yamanashi (JP)

(72) Inventors: Kazuomi MAEDA, Yamanashi (JP); Ryoutarou TSUNEKI, Yamanashi (JP)

(21) Appl. No.: 18/286,300

(22) PCT Filed: May 26, 2021
(86) PCT No.: PCT/JP2021/020069

§ 371 Date: Oct. 10, 2023

(51) Int. Cl. B23Q 17/12; G05B 19/4065

(52) U.S. Cl. CPC B23Q 17/12; G05B 19/4065; G05B 2219/37435

(57) ABSTRACT

Adjustment is performed such that vibration does not occur when a control parameter of a control device is changed, a jig or workpiece is changed, a tool is changed, the presence or absence of machining or the type of machining is changed, an industrial machine or the temperature around it has changed, or the state of lubricating oil associated with an industrial machine has changed. In particular, parameters are optimized that have the potential for causing vibration. The vibration detection device detects vibration in an industrial machine, and includes a state change detection unit for detecting a change in the state of a control device that controls the industrial machine, and a vibration determination unit for determining whether the industrial machine is vibrating. When a change in the state of the control device is detected, the presence or absence of vibration in the industrial machine is determined.

### TECHNICAL FIELD

The present invention relates to a vibration detection device.

### BACKGROUND ART

Technologies have been proposed for automating parameter adjustments of servo control devices for industrial machines such as machine tools or robots. For example, see Patent Document 1.
Patent Document 1: Japanese Unexamined Patent Application, Publication No. 2020-177257

### DISCLOSURE OF THE INVENTION

### Problems to be Solved by the Invention

Torque commands for motors, etc. could potentially cause vibration in the cases such as: changing the control parameters of control devices for industrial machines such as machine tools, injection molding machines, forging machines, and robots, or the control parameters of servo control devices for motors driving such industrial machines; changing the jigs or workpieces; changing the tools; changing the presence or absence of machining or the type of machining; changing the temperature of the industrial machines; or their surroundings; or changing the state of lubricating oil of driving units included in the industrial machines. Torque commands, etc. could potentially cause vibration when the state of the machines changes due to factors such as replacement of or positional change in workpieces or jigs.

When actual vibration occurs, vibration noise may be generated, or alarms due to such as excessive position deviation or excessive speed deviation of the control device may be generated.

However, such alarms are the functions that constantly monitor abnormalities in the control system and machine system, and their sensitivity to vibration is low, thus they are only capable of detecting vibration after they occur.

Therefore, in the case of changing the control parameters of the control device, for instance, the operator needs to manually adjust the control parameters while ensuring that no vibration occurs, which is laborious. In the case of changing the jigs, workpieces, or tools, for instance, the operator needs to manually adjust the position of jigs, workpieces, or tools while ensuring that no vibration occurs, which is laborious. In the case of changing the presence or absence of machining or the type of machining, for instance, the operator needs to adjust the machining path, etc. while ensuring that no vibration occurs, which is laborious. In the case of changing the temperature of the industrial machine or its surroundings, for instance, the operator needs to ensure that vibration due to thermal deformation of workpieces, etc. will not occur, which is laborious. In the case of changing the state of the lubricating oil of the driving unit included in the industrial machine, for instance, the operator needs to ensure that vibration due to the changed state of the lubricating oil will not occur, which is laborious.

Further, in the case of automatic adjustments, vibration could potentially occur while the operator is not monitoring, and it takes time to stop the vibration, which is a problem.

Therefore, safe and automatic adjustment is desired while preventing vibration in the cases such as: changing the control parameters of the control device; changing the jigs or workpieces; changing the tools; changing the presence or absence of machining or the type of machining; changing the temperature of the industrial machine or its surroundings; or changing the state of lubricating oil of the driving unit included in the industrial machine. In particular, even in the case of automatically adjusting the control parameters, the parameters that could potentially cause vibration are desired to be optimized safely and automatically.

### Means for Solving the Problems

One aspect of the vibration detection device of the present disclosure is a vibration detection device that detects presence or absence of vibration in an industrial machine, in which the vibration detection device includes: a state change detection unit configured to detect a change in a state of a control device that controls the industrial machine, and a vibration determination unit configured to determine whether the industrial machine is vibrating, in which, when the state change detection unit detects a change in the state of the control device, the vibration determination unit determines presence or absence of vibration in the industrial machine.

### Effects of the Invention

According to one aspect, safe and automatic adjustment can be performed while preventing vibration in the cases such as: changing the control parameters of control devices; changing the jigs or workpieces; changing the tools; changing the presence or absence of machining or the type of machining; changing the temperature of the industrial machines or their surroundings; or changing the state of lubricating oil of driving units included in the industrial machines. In particular, even in the case of automatically adjusting the control parameters, the parameters that could potentially cause vibration can be optimized safely and automatically.

### BRIEF DESCRIPTION OF THE DRAWINGS

FIG. 1 is a diagram illustrating an example of a configuration of a system according to one embodiment;

FIG. 2 is a diagram illustrating an example of sensor data indicating vibration of a machine tool;

FIG. 3 is a diagram illustrating an example of a relationship between the sensor data and a threshold; and

FIG. 4 is a flowchart illustrating determination processing of a vibration detection device.

### PREFERRED MODE FOR CARRYING OUT THE INVENTION

### One Embodiment

First, an outline of the present embodiment will be described. In the present embodiment, the vibration detection device is a vibration detection device that detects presence or absence of vibration in an industrial machine, and determines presence or absence of vibration in the industrial machine when detecting a change in the state of a control device that controls the industrial machine.

Thus, the present embodiment can solve the problem of “even in the case of automatically adjusting the control parameters, the parameters that could potentially cause vibration can be optimized safely and automatically” as mentioned in the section “Problems to be Solved by the Invention”.

The above is an outline of the present embodiment.

Next, the configuration of the present embodiment will be described in detail using the drawings. In the present embodiment, changes in control parameters are illustrated as an example of changes in the state of the control device. Note that the present invention can also be applied to the changes such as: replacement of workpieces or jigs, changes in the position of each of a plurality of shafts included in the industrial machines, changes in the tools, changes in the presence or absence of machining or the type of machining, changes in the temperature of the industrial machine or its surroundings, changes in the state of the lubricating oil of the driving unit included in the industrial machine.

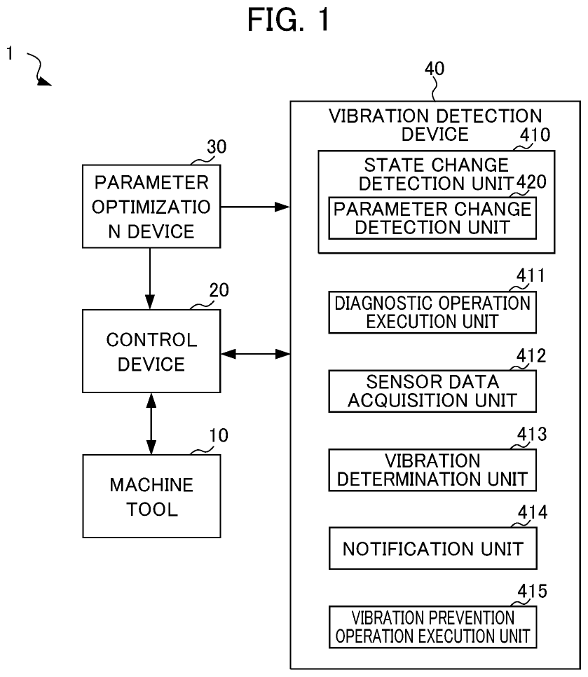

FIG. 1 is a diagram illustrating an example of a system configuration according to the present embodiment. As illustrated in FIG. 1, a system 1 includes a machine tool 10, a control device 20 that controls the machine tool 10, a parameter optimization device 30, and a vibration detection device 40.

The machine tool 10, the control device 20, the parameter optimization device 30, and the vibration detection device 40 may be directly interconnected via a connection interface (not illustrated). The machine tool 10, the control device 20, the parameter optimization device 30, and the vibration detection device 40 may be interconnected via a network (not illustrated), such as a LAN (Local Area Network) or the Internet. In this case, the machine tool 10, the control device 20, the parameter optimization device 30, and the vibration detection device 40 are provided with a communication unit (not illustrated) for mutual communication via such connection.

### <Machine Tool 10>

The machine tool 10 is a machine tool (for example, a machining tool such as a 3-axis or 5-axis machine) well-known to those skilled in the art, and operates based on operation commands of the control device 20 to be described later.

### <Control Device 20>

Control device 20 is, for example, a numerical control device or servo control device well-known to those skilled in the art, which generates operation commands based on control information, and sends the generated operation commands to the machine tool 10. In this manner, the control device 20 controls operations of the machine tool 10.

Specifically, the control device 20 is a device that controls the machine tool 10 to perform predetermined machining. The control device 20 is given a machining program describing the operations of the machine tool 10. The control device 20 creates operation commands, including shifting commands for each shaft, rotation commands for the motor that drives the main shaft, etc., based on the given machining program, and sends these operation commands to the machine tool 10 to control the motor of the machine tool 10. As a result, the machine tool 10 performs predetermined machining.

### <Parameter Optimization Device 30>

The parameter optimization device 30 is, for example, a computer or the like, and may serve as a parameter change unit that changes control parameters such as speed gain in the control device 20 by machine learning.

Optimization of parameters can be performed by using known methods (see Patent Document 1, etc.) to search for optimal values by machine learning. For instance, the parameter optimization device 30 changes the parameters to parameters decided by machine learning when searching for optimal values of parameters such as speed gain (speed gain, resonance avoidance filter, other current loop gain, etc.) by machine learning.

For example, when raising the speed gain included in the control parameters, the parameter optimization device 30 may gradually change the speed gain to suppress vibration from suddenly occurring.

The parameter optimization device 30 is described as a device different from the control device 20 and the vibration detection device 40, but may be included in the control device 20 or the vibration detection device 40.

### <Vibration Detection Device 40>

As illustrated in FIG. 1, the vibration detection device 40 includes: a state change detection unit 410 that includes a parameter change detection unit 420; a diagnostic operation execution unit 411; a sensor data acquisition unit 412; a vibration determination unit 413; a notification unit 414; and a vibration prevention operation execution unit 415.

The vibration detection device 40 is provided with a calculation processing device such as a CPU (Central Processing Unit) (not illustrated) to implement the operations of the functional blocks illustrated in FIG. 1. The vibration detection device 40 is provided with auxiliary storage devices (not illustrated) such as ROM (Read Only Memory) or HDD for storing various control programs, and main storage devices (not illustrated) such as RAM (Random Access Memory) for temporarily storing data needed for the calculation processing device to execute programs.

In the vibration detection device 40, the calculation processing device reads the OS and application software from the auxiliary storage device, expands the read OS and application software in the main storage device, and performs calculation processing based on these OS and application software. The vibration detection device 40 controls each hardware, based on the results of this calculation. As a result, the functions of the state change detection unit 410, the diagnostic operation execution unit 411, the sensor data acquisition unit 412, the vibration determination unit 413, the notification unit 414, and the vibration prevention operation execution unit 415 are implemented. In other words, the vibration detection device 40 can be implemented by collaboration of hardware and software.

When the control parameters (such as speed gain) of the control device 20 are changed by the parameter optimization device 30, the state change detection unit 410 detects that the state of the control device 20 is changed.

For example, when the state change detection unit 410 detects that the state of the control device 20 is changed, the diagnostic operation execution unit 411 commands the control device 20 to execute a diagnostic operation.

Specifically, for example, in a state where the diagnostic target shaft included in the machine tool 10 is stopped by the parameter optimization device 30, the diagnostic operation execution unit 411 causes the control device 20 to acquire time-series data such as torque commands, speed deviations, and position deviations for the diagnostic target shaft, for a predetermined period (hereinafter also referred to as “diagnostic period”) (such as 5 seconds) from immediately after changing the control parameter of the control device 20. In other words, while the diagnostic target shaft is moving by acceleration or deceleration, the acceleration or deceleration requires torque, thus the torque components used for suppressing the vibration become unclear; therefore, the control device 20 can acquire only the torque component for suppressing the vibration in the state where the diagnostic target shaft is stopped. Therefore, while the diagnostic target shaft of the machine tool 10 is operating at a constant speed during the diagnostic period (such as 5 seconds) by the control device 20, the diagnostic operation execution unit 411 may cause the control device 20 to acquire time-series data such as torque commands for the diagnostic target shaft.

The sensor data acquisition unit 412 acquires sensor data from the machine tool 10 and/or the control device 20.

Specifically, for example, the sensor data acquisition unit 412 acquires time-series data of control data such as a torque command (current command) for the diagnostic target shaft, position deviation, and speed deviation acquired by the control device 20 (or the servo controller (not illustrated) included in the control device 20) based on the diagnostic operation of the diagnostic operation execution unit 411, as sensor data from the control device 20.

The vibration frequency depends on the machine tool 10, and is tens to hundreds of Hz; for example, when the vibration frequency is 50 to 200 Hz, one cycle will be 5 to 20 milliseconds.

Therefore, the sensor data acquisition unit 412 acquires time-series data such as torque commands for the diagnostic target shaft as observed by the control device 20, from the control device 20 every T seconds (for example, approximately 50 to 100 milliseconds) during which several peaks can be observed.

The sensor data acquisition unit 412 may directly acquire sensor data without the control device 20 every T seconds (for example, approximately 50 to 100 milliseconds) from external sensors (not illustrated) such as an acceleration sensor, a vibrometer, a laser length measuring machine, or a temperature sensor, which are arranged in the machine tool 10.

When a change in the state of the control device 20 is detected, the vibration determination unit 413 determines presence or absence of vibration in the machine tool 10, based on the sensor data acquired by the sensor data acquisition unit 412.

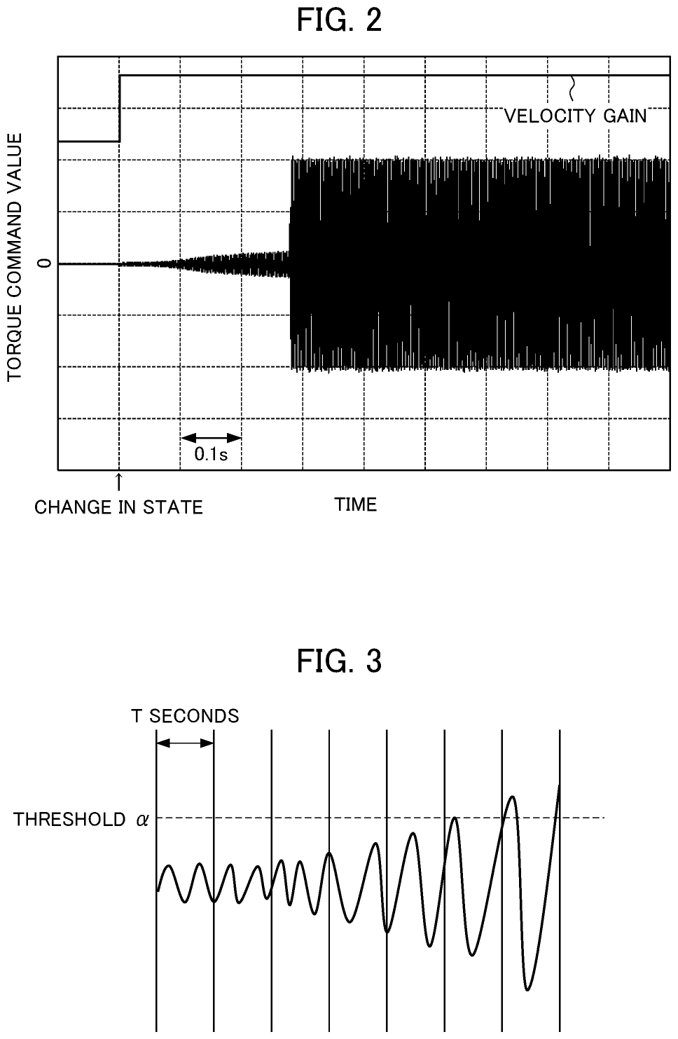

FIG. 2 is a diagram illustrating an example of sensor data indicating vibration of the machine tool 10. The sensor data in FIG. 2 is time-series data of the torque command for the diagnostic target shaft, which is acquired by the control device 20. In FIG. 2, the vertical axis represents torque command values, and the horizontal axis represents time. One division on the horizontal axis represents, for example, 0.1 seconds (T seconds). The solid line represents time-series data of the speed gain, showing a change (in other words, change in the state of the control device 20) at the time in the first division.

As illustrated in FIG. 2, as a result of the change in the speed gain, the torque command value gradually increases in amplitude and starts to vibrate approximately 0.3 seconds later. This indicates that even if the diagnostic target shaft is stopped, in a state where the speed gain is high (i.e., in a state where the feedback gain is increased), even a slight change in speed generates a counteracting torque to suppress the increase, and since the torque is excessively large, vibration in the opposite direction occurs and gradually increases.

Therefore, for example, as illustrated in FIG. 3, from immediately after detecting the change in the state of the control device 20, the vibration determination unit 413 determines whether the torque command value acquired by the sensor data acquisition unit 412 exceeds a predetermined threshold α, every T seconds (such as 0.1 seconds). When the torque command value exceeds the threshold α, the vibration determination unit 413 determines that the machine tool 10 is vibrating.

Note that the vibration determination unit 413 may calculate a half amplitude value from the torque command value acquired by the sensor data acquisition unit 412 every T seconds (such as 0.1 seconds), and determine whether the calculated half amplitude value exceeds a predetermined threshold, whereby determining presence or absence of vibration in the machine tool 10. This allows the vibration determination unit 413 to take into account the effect of gravity which may cause a shift in the zero point when determining presence or absence of vibration.

The vibration determination unit 413 may also perform a Fast Fourier Transform (FFT) on the sensor data acquired by the sensor data acquisition unit 412 every T seconds (such as 0.1 seconds), and determine whether the amplitude of a specific frequency exceeds a predefined threshold, whereby determining presence or absence of vibration in the machine tool 10. This allows the vibration determination unit 413 to limit the amplitude of the frequency specific to the machine or the amplitude of a certain range of frequencies.

The vibration determination unit 413 may determine whether the rate of increase in the sensor data acquired by the sensor data acquisition unit 412 exceeds a predefined threshold every T seconds (such as 0.1 seconds), whereby determining presence or absence of vibration in the machine tool 10.

The vibration determination unit 413 may statistically process (e.g., by Maharanobis-Taguchi (MT) method) the sensor data acquired by the sensor data acquisition unit 412 every T seconds (such as 0.1 seconds), and determine whether the statistically processed value exceeds a predefined threshold, whereby determining presence or absence of vibration in the machine tool 10. Alternatively, when the statistically processed value is increasing, the vibration determination unit 413 may determine that the machine tool 10 is vibrating.

When the vibration determination unit 413 determines that the machine tool 10 is vibrating, the notification unit 414 provides notification to that effect.

Specifically, for example, the notification unit 414 displays a determination result or alarm indicating that the machine tool 10 is vibrating, on a display unit (not illustrated) such as an LCD display included in the machine tool 10, the control device 20, or the vibration detection device 40.

In this manner, the vibration detection device 40 can promptly notify the operator or the like.

The notification unit 414 may also provide notification through a speaker (not illustrated).

When the vibration determination unit 413 determines that the machine tool 10 is vibrating, the vibration prevention operation execution unit 415 automatically avoids vibration of the machine tool 10.

Specifically, for example, the vibration prevention operation execution unit 415 avoids vibration of the machine tool 10 by lowering the control gain such as speed gain, stopping the driving unit (not illustrated) of the machine tool 10, or making an emergency stop of a drive amplifier (not illustrated) included in the machine tool 10.

### <Determination Processing of Vibration Detection Device 40>

Next, the operation related to determination processing of the vibration detection device 40 according to the present embodiment will be described.

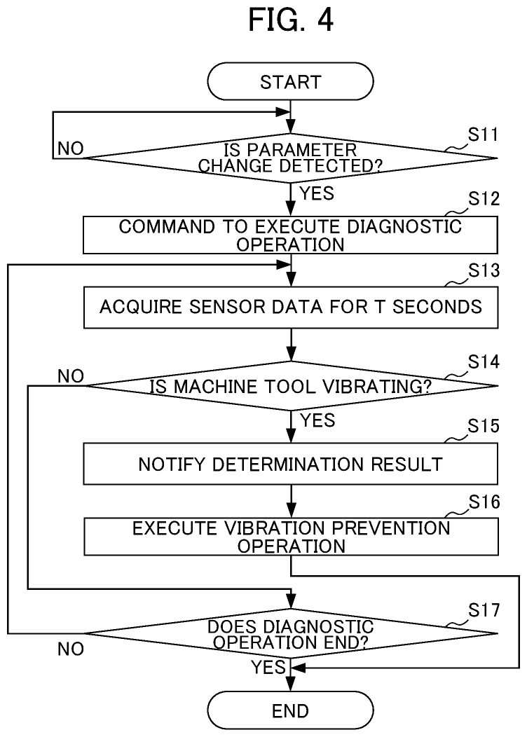

FIG. 4 is a flowchart illustrating determination processing of the vibration detection device 40. The flow illustrated herein is performed each time the control parameter is changed by the parameter optimization device 30.

In Step S11, the state change detection unit 410 determines whether a change in the control parameters of the control device 20 by the parameter optimization device 30 is detected. If a change is detected in the control parameters of the control device 20, the processing advances to Step S12. On the other hand, if a change is not detected in the control parameters of the control device 20, the processing waits until detecting a change in parameters.

In Step S12, the diagnostic operation execution unit 411 commands the control device 20 to execute a diagnostic operation.

In Step S13, the sensor data acquisition unit 412 acquires sensor data from the machine tool 10 and/or the control device 20 for T seconds (such as 0.1 seconds).

In Step S14, based on the sensor data acquired in Step S13, the vibration determination unit 413 determines whether the machine tool 10 is vibrating, immediately after detecting the change in the state of the control device 20. If the machine tool 10 is vibrating, the processing advances to Step S15. On the other hand, if the machine tool 10 is not vibrating, the processing advances to Step S17.

In Step S15, the notification unit 414 provides notification of the determination result indicating that the machine tool 10 is vibrating.

In Step S16, the vibration prevention operation execution unit 415 automatically avoids vibration of the machine tool 10 as determined in Step S14. Then, the vibration detection device 40 ends the determination processing.

In Step S17, the diagnostic operation execution unit 411 determines whether the diagnostic operation ended over the diagnostic period (such as 5 seconds). If the diagnostic operation ended over the diagnostic period, the vibration detection device 40 ends the determination processing. On the other hand, if the diagnostic operation did not end within the diagnostic period, the processing returns to Step S13.

As a result, the vibration detection device 40 according to one embodiment provides a diagnostic period for determining vibration immediately after changing a parameter that could potentially cause vibration, and when the machine tool 10 is determined to be vibrating, the parameter is corrected or the machine tool 10 is stopped, whereby enabling safe and automatic optimization of the parameters that could potentially cause vibration, even when automatically adjusting the control parameters.

The vibration detection device 40 can detect with high sensitivity (rapid detection at appropriate threshold) by limiting detection to only when vibration is likely to occur, such as when adjusting the parameters or replacing the jigs or workpieces.

The vibration detection device 40 detects at short intervals of T seconds (such as 0.1 seconds), and gradually increases the control parameter over several times instead of sudden increase all at once, whereby enabling quick detection of vibration before the vibration occurs due to such sudden increase.

One embodiment has been described above; however, the vibration detection device 40 is not limited to the aforementioned embodiment and includes modifications and improvements within the range that can achieve the purpose.

### Modified Example 1

In the one embodiment, the vibration detection device 40 has the function of the parameter change detection unit 420 serving as the state change detection unit; however, the present invention is not limited thereto. For example, the vibration detection device 40 serving as the state change detection unit may include at least one of the functions of: a driven body change detection unit that detects a change in jigs or workpieces; a tool change detection unit that detects a change in tools of the machine tool 10; a machining state detection unit that detects presence or absence of machining or the type of machining such as rough machining or finish machining; a temperature state detection unit that detects temperature of the machine tool 10 or surroundings of the machine tool 10; or a lubrication state detection unit that detects a state of the lubricating oil of the driving unit (not illustrated) included in the machine tool 10.

In this manner, even in the cases such as: changing the jigs or workpieces, changing the tool, changing the presence or absence of machining or the type of machining, changing the temperature of the industrial machine or its surroundings, or changing the state of lubricating oil of the driving unit included in the industrial machine, the vibration detection device 40 may cause the control device 20 to stop the diagnostic target shaft included in the machine tool 10 for a diagnostic period (such as 5 seconds) immediately after changing the state of the machine tool 10, and acquire time-series data (sensor data) such as torque commands for the diagnostic target shaft during the diagnostic period, from the control device 20, as well as acquiring sensor data from external sensors such as an acceleration sensor. The vibration detection device 40 determines presence or absence of vibration in the machine tool 10, based on the sensor data acquired every T seconds (for example, approximately 50 to 100 milliseconds), whereby enabling safe and automatic adjustments while preventing vibration.

### Modified Example 2

For example, in the above embodiment, the vibration detection device 40 has been described as a device different from the control device 20; however, the control device 20 may be provided with part or all of the functions of the vibration detection device 40.

Alternatively, for example, the server may be provided with part or all of the state change detection unit 410, the diagnostic operation execution unit 411, the sensor data acquisition unit 412, the vibration determination unit 413, the notification unit 414, and the vibration prevention operation execution unit 415 of the vibration detection device 40. Each function of the vibration detection device 40 may be implemented using virtual server functions, etc., on the cloud.

Further, the vibration detection device 40 may also be a distributed processing system, with the functions of the vibration detection device 40 appropriately distributed across a plurality of servers.

### Modified Example 3

For example, in the above embodiment, the parameter optimization device 30 has been described as a device different from the control device 20 and the vibration detection device 40; however, the present invention is not limited thereto. For instance, the parameter optimization device 30 may be included in the control device 20 or the vibration detection device 40.

Each function included in the vibration detection device 40 in one embodiment can be implemented by hardware, software, or a combination thereof. Implementation by software herein means implementation by a computer reading and executing a program.

A program can be stored using various types of non-transitory computer-readable media and can be supplied to a computer. Non-transitory computer-readable media include various types of tangible storage media. Examples of non-transitory computer-readable media include magnetic recording media (for example, flexible disks, magnetic tapes, hard disk drives), magneto-optical recording media (for example, magneto-optical disks), CD-ROM (Read Only Memory), CD-R, CD-R/W, and semiconductor memories (for example, mask ROM, PROM (Programmable ROM), EPROM (Erasable PROM), flash ROM, RAM). The program may also be supplied to a computer by various types of transitory computer-readable media. Examples of transitory computer-readable media include electrical signals, optical signals, and electromagnetic waves. Transitory computer-readable media can supply a program to a computer via wired communication paths such as electric wires and optical fibers, or wireless communication paths.

Note that the steps describing the program to be recorded on the recording medium include not only processes that are performed in chronological order along the sequence, but also processes that are not necessarily processed chronologically and can be executed in parallel or individually.

In other words, the vibration detection device of the present disclosure can take various forms with various configurations, as follows.

(1) The vibration detection device 40 of the present disclosure is a vibration detection device that detects presence or absence of vibration in the machine tool 10, and includes the state change detection unit 410 configured to detect a change in the state of the control device 20 that controls the machine tool 10, and the vibration determination unit 413 configured to determine whether the machine tool 10 is vibrating, in which the vibration determination unit 413 determines presence or absence of vibration in the machine tool 10 when the state change detection unit 410 detects a change in the state of the control device 20.

According to the vibration detection device 40, safe and automatic adjustment can be performed while preventing vibration, in the cases such as changing the control parameters of the control device, changing the jigs or workpieces, changing the tools, changing the presence or absence of machining or the type of machining, changing the temperature of the industrial machine or its surroundings, or changing the state of lubricating oil of the driving unit included in the industrial machine. In particular, even in the case of automatically adjusting the control parameters, the parameters that could potentially cause vibration can be optimized safely and automatically.

Note that the machine tool 10 includes, for example, turning machines, machining centers, electrical discharge machines, laser beam machines, etc. The present invention is not limited to machine tools, and may be applied to any types of industrial machines which could potentially vibrate, such as injection molding machines, robots, etc.

(2) In the vibration detection device 40 described in (1), the state change detection unit 410 may include at least one of the parameter change detection unit 420 configured to detect a change in the control parameters of the control device 20, the driven body change detection unit configured to detect a change in jigs or workpieces, the tool change detection unit configured to detect a change in tools, the machining state detection unit configured to detect presence or absence of machining or the type of machining, the temperature state detection unit configured to detect temperature of the machine tool 10 or surroundings of the machine tool 10, or the lubrication state detection unit configured to detect a state of the lubricating oil of the driving unit included in the machine tool 10.

In this manner, the vibration detection device 40 can perform safe and automatic adjustments with high accuracy while preventing vibration.

(3) The vibration detection device 40 described in (2) may include the parameter optimization device 30 configured to change the control parameters by machine learning.

In this manner, the vibration detection device 40 can set optimal parameters even in the case of changing the machine characteristics.

(4) In the vibration detection device 40 described in any one of (1) to (3), the state change detection unit 410 may further include the diagnostic operation execution unit 411 configured to command the control device 20 to execute a diagnostic operation when detecting a change in the state of the control device 20, and the sensor data acquisition unit 412 configured to acquire sensor data from the machine tool 10 and/or the control device 20, in which the vibration determination unit 413 may determine presence or absence of vibration in the machine tool 10, based on the sensor data acquired by the sensor data acquisition unit 412.

In this manner, the vibration detection device 40 can detect vibration of the machine tool 10 with higher accuracy.

(5) In the vibration detection device 40 described in any one of (1) to (4), the vibration determination unit 413 may determine presence or absence of vibration in the machine tool 10 while the diagnostic target shaft included in the machine tool 10 is stopped by the control device 20.

In this manner, the vibration detection device 40 can detect vibration of the machine tool 10 with higher accuracy.

(6) In the vibration detection device 40 described in (4), the sensor data acquisition unit 412 may acquire the control data of the control device 20 or the sensor value detected by an external sensor, as the sensor data.

In this manner, the vibration detection device 40 can detect vibration of the machine tool 10 with high accuracy.

(7) The vibration detection device 40 described in any one of (1) to (6) may further include the notification unit 414 configured to provide notification when the vibration determination unit 413 determines that the machine tool 10 is vibrating.

In this manner, the vibration detection device 40 can promptly notify the operator or the like.

(8) The vibration detection device 40 described in any one of (1) to (7) may further include the vibration prevention operation execution unit 415 configured to automatically avoid vibration when the vibration determination unit 413 determines that the machine tool 10 is vibrating.

In this manner, the vibration detection device 40 can automatically avoid vibration of the machine tool 10 even when the operator is not monitoring.

(9) In the vibration detection device 40 described in (4), the vibration determination unit 413 may determine that the machine tool 10 is vibrating, if the statistically processed value of the sensor data acquired by the sensor data acquisition unit 412 is increasing while the diagnostic target shaft included in the machine tool 10 is stopped.

In this manner, the vibration detection device 40 can accurately detect vibration of the machine tool 10.

(10) In the vibration detection device 40 described in (4), the sensor data acquired by the sensor data acquisition unit 412 may be a torque command of the control device 20.

In this manner, the vibration detection device 40 can detect vibration of the machine tool 10 with high accuracy.

### EXPLANATION OF REFERENCE NUMERALS

1: system
10: machine tool
20: control device
30: parameter optimization device
40: vibration detection device
410: state change detection unit
411: diagnostic operation execution unit
412: sensor data acquisition unit
413: vibration determination unit
414: notification unit
415: vibration prevention operation execution unit
420: parameter change detection unit

1. A vibration detection device that detects presence or absence of vibration in an industrial machine, the vibration detection device comprising:
a state change detection unit configured to detect a change in a state of a control device that controls the industrial machine; and
a vibration determination unit configured to determine whether the industrial machine is vibrating,
wherein, when the state change detection unit detects a change in the state of the control device, the vibration determination unit determines presence or absence of vibration in the industrial machine.

2. The vibration detection device according to claim 1, wherein
the state change detection unit includes at least one of: a parameter change detection unit configured to detect a change in a control parameter of the control device; a driven body change detection unit configured to detect a change in a jig or workpiece; a tool change detection unit configured to detect a change in a tool; a machining state detection unit configured to detect presence or absence of machining or a type of machining; a temperature state detection unit configured to detect temperature of the industrial machine or surroundings of the industrial machine; or a lubrication state detection unit configured to detect a state of lubricating oil of a driving unit included in the industrial machine.

3. The vibration detection device according to claim 2, further comprising:
a parameter change unit configured to change the control parameter by machine learning.

4. The vibration detection device according to claim 1, further comprising:
a diagnostic operation execution unit configured to command the control device to execute a diagnostic operation when the state change detection unit detects a change in the state of the control device; and
a sensor data acquisition unit configured to acquire sensor data from the industrial machine and/or the control device,
wherein the vibration determination unit determines presence or absence of vibration in the industrial machine, based on the sensor data acquired by the sensor data acquisition unit.

5. The vibration detection device according to claim 1, wherein
the vibration determination unit determines presence or absence of vibration in the industrial machine when a diagnostic target shaft included in the industrial machine is stopped by the control device.

6. The vibration detection device according to claim 4, wherein
the sensor data acquisition unit acquires control data of the control device or a sensor value detected by an external sensor, as the sensor data.

7. The vibration detection device according to claim 1, further comprising:
a notification unit configured to, when the vibration determination unit determines that the industrial machine is vibrating, provide a notification to that effect.

8. The vibration detection device according to claim 1, further comprising:
a vibration prevention operation execution unit configured to automatically avoid the vibration when the vibration determination unit determines that the industrial machine is vibrating.

9. The vibration detection device according to claim 4, wherein
the vibration determination unit determines that the industrial machine is vibrating when a statistically processed value of the sensor data acquired by the sensor data acquisition unit is increasing while the diagnostic target shaft included in the industrial machine is stopped.

10. The vibration detection device according to claim 4, wherein
the sensor data acquired by the sensor data acquisition unit is a torque command of the control device.
